(19) United States
(12) Patent Application Publication
(10) Pub. No.: US 2019/0060737 A1
(43) Pub. Date: Feb. 28, 2019

(54) Skateboard Brake with Replaceable Friction Element

(71) Applicant: David Ewing Glass, Knoxville, TN (US)

(72) Inventor: David Ewing Glass, Knoxville, TN (US)

(21) Appl. No.: 15/691,709

(22) Filed: Aug. 30, 2017

(51) Int. Cl. A63C 17/14; B60T 1/14

(52) U.S. Cl. CPC A63C 17/1436; A63C 2017/1463; B60T 1/14

(57) ABSTRACT

According to one aspect, an apparatus for reducing the speed or acceleration of motion of a skateboard and its user is disclosed. According to one embodiment, the apparatus includes one or more friction elements that are removably affixed to a substantially flat resilient member at a location near the first end of the resilient member typically proximate to the rear wheel mounting truck; the resilient member is then affixed by fasteners upon its opposite and second end to the underneath face of the platform of the skateboard, typically proximate to or forward of the center of the platform. The apparatus also includes a substantially rigid linkage that penetrates the skateboard platform and is affixed to near the first end of the resilient member for the purpose of interfacing the first end of the resilient member selectively to one foot of a user of the skateboard, such that when the user desires to reduce the speed or acceleration of the skateboard the user applies to the linkage a force substantially normal to the skateboard platform and therefore the resilient member. The force applied to the resilient member causes the friction element or elements to contact the riding surface, creating by the contact of the friction element or elements with the riding surface a frictional force that is transmitted to the skateboard platform via the fixation of the second end of the resilient member to the skateboard, opposingly counteracting the velocity or acceleration of the skateboard and user, thereby slowing the motion. The frictional force is modulated by the variable force applied to the apparatus by the user.

### CROSS-REFERENCE TO RELATED PATENT APPLICATION

This application claims the benefit, pursuant to 35 U.S.C. § 119(e), of U.S. Provisional Patent Application Ser. No. 62/495,159, filed Sep. 6, 2016, entitled “Skateboard Brake with Replaceable Friction Element” by David E. Glass, which is herein incorporated by reference in its entirety.

### BACKGROUND

A skateboard, typically comprised of a substantially planar platform or “deck” with tapered or rounded ends, upon one side of which is affixed a pair of “trucks” located near the front and rear of the deck, with the trucks providing support and steering capability for typically four wheels, may be used for various recreational and athletic activities, and for transportation. A rider, typically known in the activity as a “skater,” places his/her feet in preferred positions on the top surface of the skateboard deck, with the feet typically positioned at angles across the longitudinal axis of the deck plane, and near the front and rear of the deck. Skateboards are typically sized and configured for varying activities, including but not limited to riding tricks on flat surfaces; ramp, half-pipe, bowl, and obstacle riding; and transiting distances, sometimes called “cruising,” on flat or inclined surfaces such as streets and roads, parking lots, plazas, and sidewalks. Longer skateboards used for the cruising and downhill riding activities are sometimes called “longboards” in the trade and by skaters.

A skateboard is by its nature a free-rolling, steerable device that can gain substantial speed when ridden on inclined surfaces or by “pedaling” the board with one foot to gain speed while the other foot remains on the skateboard. While gaining and sustaining speed are relatively easily obtained skills, slowing and stopping the forward motion is much more difficult. Skaters have developed techniques such as “sliding” the board perpendicular to its direction of motion, dragging the sole of one shoe adjacent to the skateboard, or in the case of skateboards with extended “kicktails,” lifting one end of the skateboard from the riding surface to cause the kicktail to drag the surface. All of these techniques require much expertise, training, and practice, and have varying success at slowing the skateboard's forward motion, since they can be dependent upon the wheel material, skateboard speed, friction material, available area and slope of the riding surface, configuration of the skateboard, and skill of the skater. For a longboard, the trucks and wheels are typically mounted nearer the front and rear of the deck than on a trick skateboard, making the example techniques more difficult. Often the only technique used by longboard riders is to step off the deck while the skateboard is moving, sometimes leading to dangerous falls due to the speed of the skateboard exceeding the running and balancing capacity of the skater.

It is therefore observed that a simple and inexpensive brake is a useful accessory when incorporated to a skateboard, especially to longboards used in cruising activities, such that a skater of novice or moderate skill is able to control the forward speed, including bringing the skateboard to a safe, full stop. The brake system should have adjustability and incorporate one or more easily replaceable friction elements or “brake pads.” A brake system incorporating these criteria has been developed and tested, and will be so described in detail in the following descriptions and drawings.

It is with respect to these and other considerations that the various aspects and exemplary embodiments are presented below.

### SUMMARY

In one aspect, the present disclosure relates to an apparatus for reducing the forward speed and acceleration of a skateboard, especially a skateboard of extended length and wheelbase known as a longboard. According to one or more embodiments, by using one or more replaceable friction elements, also known as brake pads, removably affixed near one end of a largely flat resilient member that is affixed upon its opposite end to the bottom surface of the skateboard platform, also known as the skateboard deck, the friction element may be displaced by the skateboard operator via a variably applied force upon a link penetrating the skateboard deck proximate to the rear truck, that interfaces the rider's foot with the resilient member in a direction substantially normal to the direction of the skateboard travel against the opposing force of the resilient member, such that the friction element or elements make contact with the riding surface upon which the skateboard is being operated. The frictional force vector generated by the normal force of the friction element or elements against the riding surface creates a force vector substantially directly opposed to the velocity or acceleration vector of the skateboard forward motion, thereby reducing the velocity or acceleration of the skateboard.

These and other features will be apparent from a reading of the following detailed description and a review of the associated drawings.

### BRIEF DESCRIPTION OF THE DRAWINGS

The accompanying drawings illustrate one or more embodiments of the invention and, together with the written description, serve to explain aspects of the disclosure. Wherever possible, the same reference numbers are used throughout the drawings to refer to the same or like elements of an embodiment, and wherein:

FIG. 1 shows a top view of a typical skateboard configured with an extended wheelbase and commonly known as a longboard. Highlighted is the brake actuator pedal used in one preferred embodiment of the invention.

FIG. 2 shows schematically an underneath view of one preferred embodiment of the longboard of FIG. 1, incorporating a single, replaceable friction braking element and identifying major components of the longboard, highlighting the assembly and components related to this embodiment of the invention.

FIG. 3 shows schematically an underneath view of another preferred embodiment of the longboard of FIG. 1, incorporating a multiple, replaceable friction braking elements and identifying major components of the longboard, highlighting the assembly and components related to this embodiment of the invention.

FIG. 4A shows schematically a side view of the longboard in FIG. 2 and FIG. 3, and including an enlarged section of the rear truck and brake assemblies as installed in the preferred embodiments of the invention.

FIG. 4B shows schematically a side view of the longboard in FIG. 2 and FIG. 3, demonstrating the direction of actuation of the brake pedal to cause the friction braking element(s) to contact the riding surface, and showing the braking element in contact with the riding surface.

FIG. 5A shows a skateboard rider in a typical riding position on a longboard, and highlighting the position of the rider's foot so that the brake pedal is in the normal or unactuated position of FIG. 4A.

FIG. 5B shows the skateboard rider of FIG. 5A having moved the position of the rider's back foot to engage and depress the brake pedal to cause contact of the braking element of FIG. 4A to contact the riding surface.

FIG. 6 shows schematically an exploded view of the components and assemblies employed in one preferred embodiment of the invention.

FIG. 7 shows schematically alternate configurations of preferred embodiments of the assembly configuration used in preferred embodiments of the invention, to employ single or multiple friction brake elements.

### DETAILED DESCRIPTION AND OPERATION

In the following detailed description, references are made to the accompanying drawings that form a part hereof, which illustrate specific embodiments or examples. Referring now to the drawings, aspects of the various implementations provided herein and an exemplary operating environment will be described. The terms used in this specification generally have their ordinary meanings in the art, within the context of the disclosure, and in the specific context where each term is used.

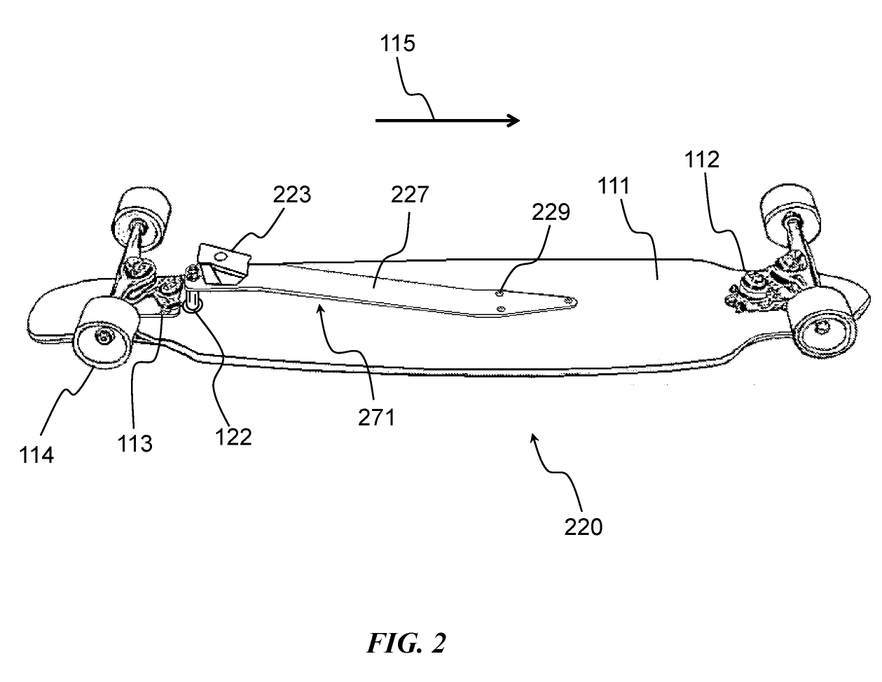

Like numerals in the drawings represent like elements throughout the several figures in accordance with Table 1 set forth below. For each numeral, the prefix number is not shown. The prefix number is specifically set forth on the drawings as the first drawing upon which the element occurs. For example, element 23 which first appears on FIG. 2 will be carried throughout the drawings as element 223.

TABLE 1
reference numerals for elements shown throughout the drawings

| Ref. | Description |
|---|---|
| 10 | Skateboard top view |
| 11 | Skateboard deck |
| 12 | Front truck |
| 13 | Rear truck |
| 14 | Wheel |
| 15 | Typical direction of skateboard travel |
| 20 | Skateboard with brake apparatus employing single friction |
| | element, bottom view |
| 21 | Skateboard with brake apparatus employing multiple friction |
| | elements, bottom view |
| 22 | Hole through skateboard deck |
| 23 | Replaceable friction brake element |
| 24 | Brake pedal normal riding position |
| 25 | Brake pedal depressed position |
| 27 | Resilient member for single friction element |
| 28 | Resilient member for multiple friction elements |
| 29 | Fasteners attaching reilient member to deck |
| 30 | Side view of skateboard, brake in normal position |
| 31 | Side view of skateboard, brake in actuated position |
| 40 | Skateboard and rider, in normal riding position |
| 41 | Skateboard and rider, with brake in actuated position |
| 42 | Rider |
| 43 | Front foot of rider |
| 44 | Rear foot of rider in normal riding position |
| 45 | Rear foot of rider positioned to interface with brake pedal |
| 47 | Direction of applied force |
| 50 | Brake element assembly |
| 52 | Brake element maximum wear indicator |
| 55 | Brake element retainer plate |
| 56 | Brake element retaining fastener |
| 57 | Hole in resilient member for friction element mounting |
| 60 | Brake actuation assembly |
| 61 | Brake pedal actuation member |
| 62 | Direction of insertion through resilient member |
| 64 | Cushioning spacer |
| 65 | Jam nut |
| 66 | Lock washer |
| 67 | Interface hole for insertion of brake pedal assembly |
| 68 | Flat washer |
| 69 | Locking insert nut |
| 70 | Riding surface |
| 71 | Brake assembly, single brake element |
| 72 | Brake assembly, multiple brake element |

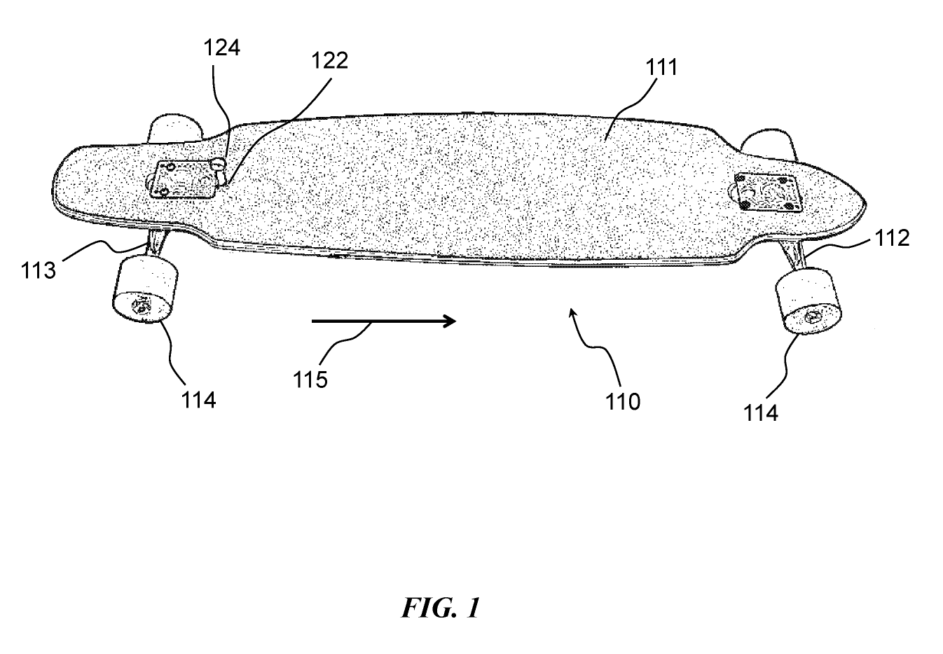

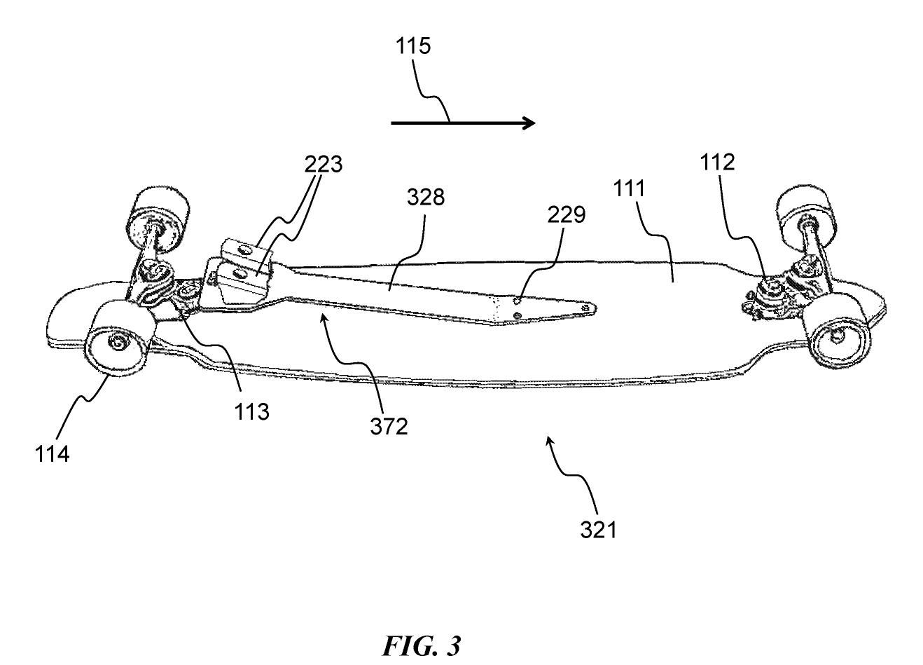

In one aspect, the present invention relates to a device for attachment to a skateboard, for the purpose of reducing the velocity or acceleration of the skateboard and rider by creating a frictional force modulated by the skateboard rider according to one preferred embodiment of the present invention, with the frictional force opposed to the motion of the skateboard. Now referring to FIG. 1, the skateboard top view 10 is shown, representing a typical configuration of a skateboard known in the trade as a longboard with wheels 14, front truck 12 and rear truck 13, is shown with the brake pedal in normal riding position 24 penetrating the skateboard deck 11 through the opening in the skateboard deck 22. The typical velocity or acceleration vector of the motion of the skateboard is represented by vector arrow 15. Now referring to FIG. 2, one preferred embodiment of the invention is shown. The skateboard with brake apparatus employing single friction element, bottom view 20 is shown, with the brake assembly, single brake element 71 incorporated to the underneath face of the skateboard deck 11. FIG. 2 also shows some major components and features of one embodiment of the present invention, namely the replaceable friction brake element 23, the resilient member for single friction element 27, and the fasteners attaching the resilient member to the deck 29. Now referring to FIG. 3, yet another preferred embodiment of the invention is shown. The skateboard with brake apparatus employing multiple friction elements, bottom view 21 is shown, with the brake assembly, multiple brake elements 72 incorporated to the underneath face of the skateboard deck 11. FIG. 3 also shows some major components and features of this embodiment of the present invention, namely the replaceable friction brake elements 23, the resilient member for multiple friction elements 28, and the fasteners attaching the resilient member to the deck 29. It should be noted that apparatus 72 shows a preferred embodiment with two friction elements 23, but the number of friction elements 23 in additional alternate embodiments may be greater than two.

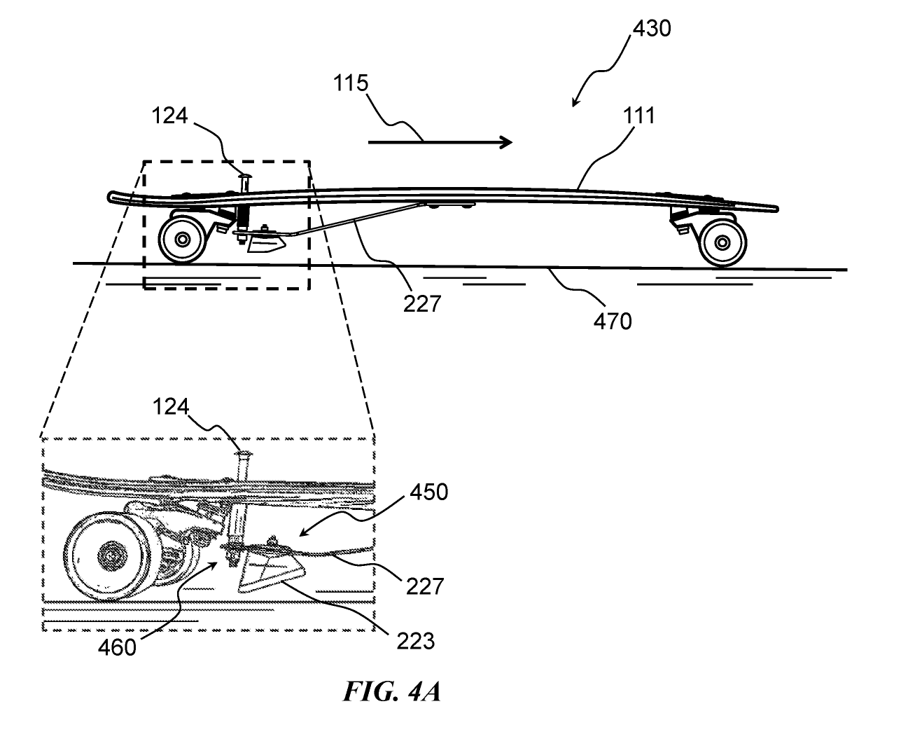

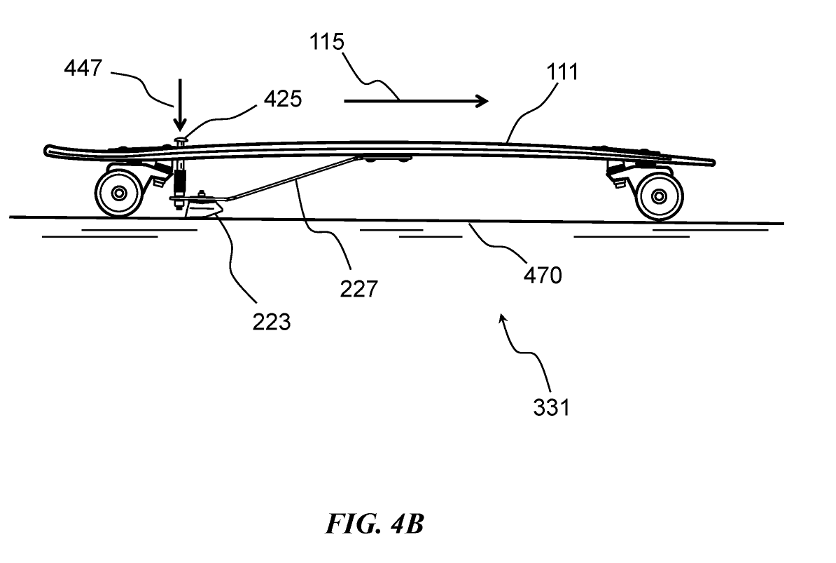

Now referring to FIG. 4A, a side view of the skateboard, brake in normal position 30 is shown, schematically representing the brake apparatus 71 or 72 of the preferred embodiments in FIG. 2 and FIG. 3. A breakout enlargement of a side view of a portion of the skateboard proximate to the rear truck 13 is shown, schematically representing a typical location and configuration of brake element subassembly 50 and brake actuation assembly 60 in one or more preferred embodiments. In FIG. 4A, the braking apparatus 71 or 72 of the present invention is shown in its unactuated, normal riding position, with the friction braking element or elements 23 not in contact with the riding surface 70, being withheld in the normal position by the force applied by resilient element 27. Now referring to FIG. 4B, a side view of the skateboard, brake in actuated position 31 is shown, schematically representing the brake apparatus 71 or 72 of the preferred embodiments in FIG. 2 and FIG. 3. In FIG. 4B, the braking apparatus 71 or 72 of the present invention is shown in its actuated, braking position, with brake pedal depressed position 25 displacing by motion of the brake actuation assembly 60 through the opening through the skateboard deck 22 as shown in FIG. 1 the brake element subassembly 50 so that the friction braking element or elements 23 are in contact with the riding surface 70, being displaced to contact with the riding surface 70 by the force 47 applied to the brake pedal in normal riding position 24 as represented in FIG. 1 and FIG. 4A.

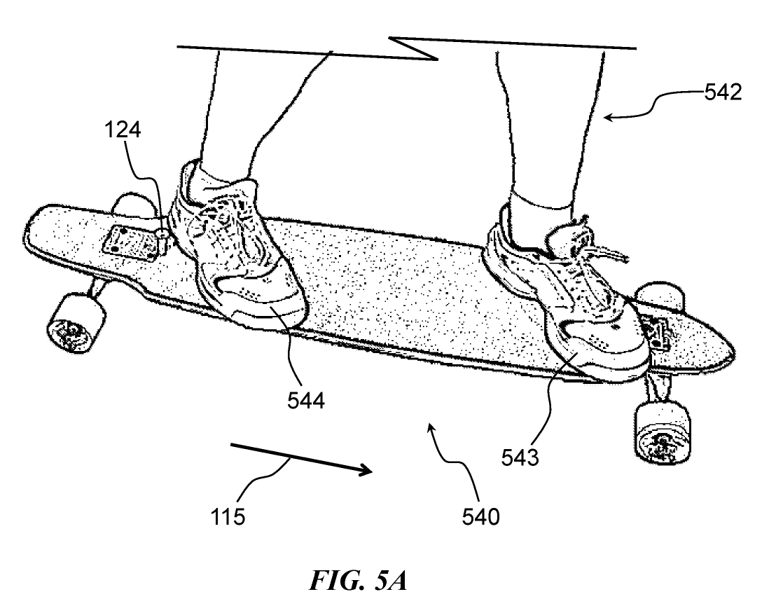

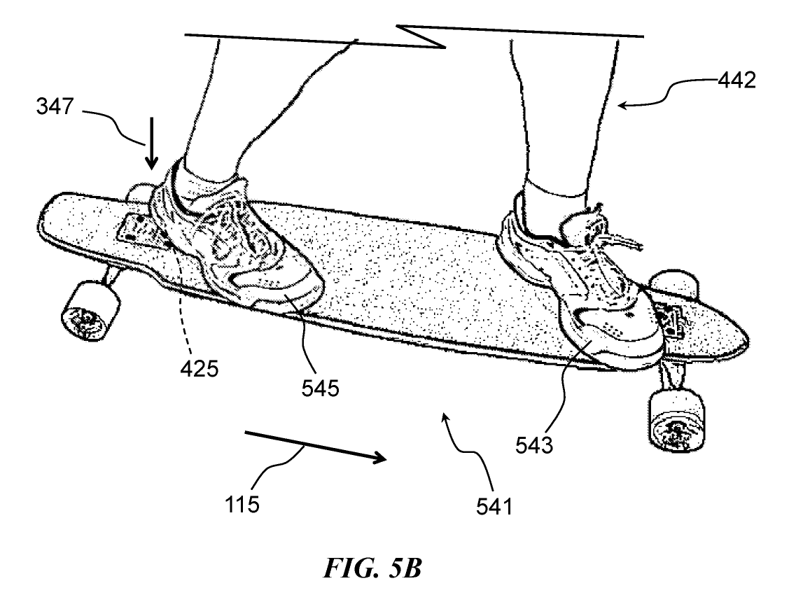

Now referring to FIG. 5A, a skateboard and rider, in normal riding position 40 is shown, supplementing the view of FIG. 1. The lower portion of rider 42 is shown with the front foot 43 and rear foot 44 in the angled positions typical of those employed by skateboard riders. The rear foot 44 is in a normal riding position, so that the brake pedal is in the normal position 24 as also shown in FIG. 1 and FIG. 3A. The typical direction of skateboard motion 15 is represented by a vector arrow. Now referring to FIG. 5B, a skateboard and rider in brake pedal depressed position 25 is shown. The rider 42 has shifted rear foot 44 so that a portion of the foot is above the brake pedal in normal riding position 24 and has applied a modulated force 47 to translate the brake pedal to the depressed position 25 as shown in FIG. 4B, so that the friction brake element or elements 23 are caused to translate in a direction approximately normal to the riding surface 70 to be in contact with the riding surface 70 as shown in FIG. 4B. The friction F created by the contact of the friction braking element or elements 23 by the normal force 47 may be represented by the formula:

F=μ×N

wherein μ is used to represent the coefficient of friction of the material comprising the friction braking element or elements 23 and N is the force applied approximately normal to the riding surface 70 by the rider's rear foot 44. The friction force thus created acts approximately opposite the forward motion represented by the vector arrow 15, thereby slowing the acceleration or motion of the rider and skateboard 41 by a factor determined by the rider's modulation of force 47.

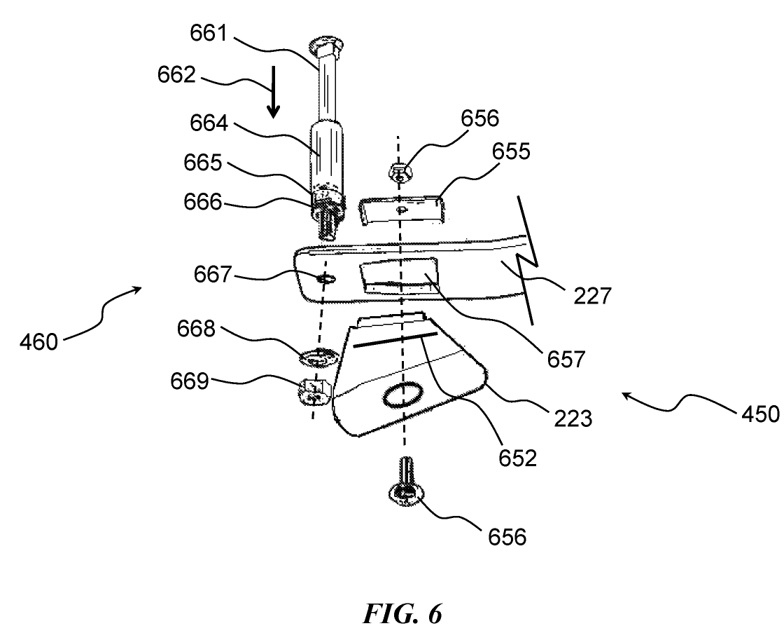

Now referring to FIG. 6, exploded views of the components of a brake element assembly 50 and a brake actuation assembly 60 are shown, as used in one or more preferred embodiments. An important element of the present disclosure is the easily replaceable friction braking element or elements 23. In expected use of the invention, material that comprises the friction brake element or elements 23 will be worn away by the abrasion of the material against typically concrete and asphalt surfaces that comprise the riding surface 70. It is therefore desirable for the skateboard user to be able to easily replace the frication brake element or elements 23 when the element or elements is worn away to a brake element maximum wear indicator 52, desirably provided as a molded feature of the friction braking element 23. Using an specially configured hole in resilient member for friction element mounting 57, brake element retaining fastener 56 and brake element retainer plate 55, the user may remove the worn friction braking element 23 and install a new friction element 23 by reassembling the components in the order demonstrated by exploded view of brake element assembly 50.

Continuing reference to FIG. 6, the brake actuation assembly 60 of one or more preferred embodiments is shown. The brake pedal actuation member 61, which may alternatively take the form of a carriage bolt, hex head bolt, button head bolt, threaded rod, pin, peg, or similar, is inserted through the opening in the skateboard deck 22, omitted here for clarity but such insertion represented here by the direction of insertion 62, then through a cushioning spacer 64 which may alternatively take the form of a substantially cylindrical material such as rubber, plastic, metal or similar, with a substantially coaxial hole sized to fit easily over the shaft of actuation member 61, thence through a jam nut 65 which may be comprised of a hex machine nut, machine nut with locking interface, or similar fastener. In order to accomplish the desirable locking feature, a separate lock washer 66, which may take the form of a split ring lock washer, star locking washer, or similar may be utilized. The typically threaded end of actuation member 61 is thence inserted through the resilient member for single friction element 27 shown here and in FIG. 2 or through a similar single hole in the resilient member for multiple friction elements 28 shown in FIG. 3 via an interface hole for insertion of brake pedal assembly 67, and thence tightened against the resilient member 27 or resilient member 28 by use of an optional flat washer 68 and a locking nut 69 which may take the form of a locking machine nut with nylon insert, machine nut with cotter pin, or similar. As the replaceable friction braking element or elements 23 experience become worn, it is desirable to allow to the user adjustment of the distance of depression of the brake pedal actuation member, hence the assembly using a threaded brake pedal actuation member 61 here represented by a carriage bolt.

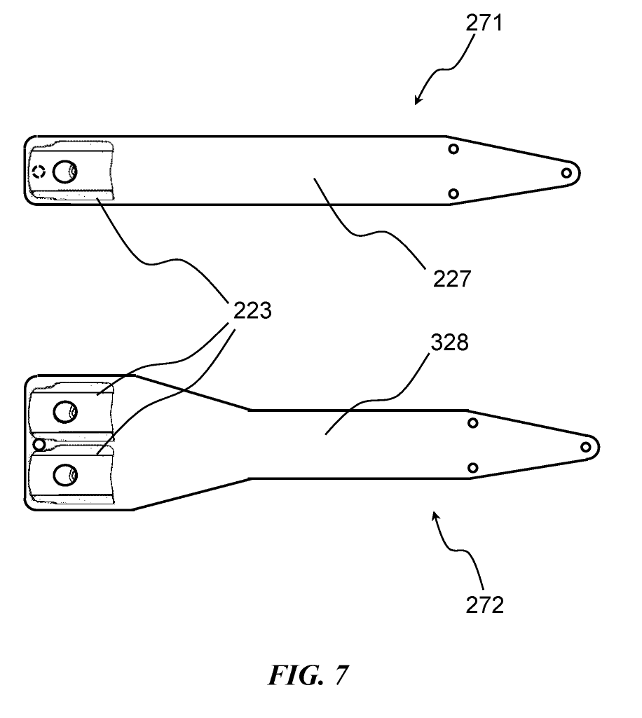

Referring now to FIG. 7, the plan view of one of the preferred embodiments, the brake assembly, single brake element 71 as shown in FIG. 2 and FIG. 6 is represented schematically at the top of the FIG. 7, and yet another preferred embodiment, the brake assembly, multiple brake elements 72 as shown in FIG. 3 is represented schematically at the bottom of FIG. 7.

The foregoing description of the exemplary embodiments has been presented in order to explain aspects of the disclosure and their practical application so as to enable others to utilize aspects of the disclosure according to various embodiments, and with various modifications as are suited to the particular use contemplated. Alternative embodiments will become apparent to those skilled in the art to which the present disclosure pertains without departing from its spirit and scope. Accordingly, the scope of the present disclosure is defined by the appended claims rather than the foregoing description and the exemplary embodiments described therein.

What is claimed is:

1. An apparatus for controlling a skateboard moving on a ground surface, comprising:
a beam member coupled at a first end to a bottom surface of the deck of the skateboard and having an opposite, second end;
one or more friction elements coupled to the beam member proximate the second end thereof; and
an actuation assembly including
a moveable member having a first end extending through the deck above a top surface of the deck, and a second end coupled to the beam member at a location below the bottom surface of the deck and proximate the second end of the beam member, wherein the moveable member is configured such that, in response to a force applied to the first end of the moveable member, the second end of the movable member urges the second end of the beam member in a direction away from the bottom surface of the deck and towards the ground surface,
wherein the one or more friction elements are coupled to the second end of the beam member such that when the second end of the beam member is urged in the direction away from the bottom of the skateboard deck and reaches a position proximate the ground surface, the one or more friction elements are applied to the ground surface creating a friction force to reduce the rate of movement of the skateboard on the ground surface.

2. The apparatus of claim 1, wherein the beam member is configured such that when the force applied to the first end of the moveable member has been released, the one or more friction elements are removed from the ground surface and the second end of the beam member returns in a direction towards the bottom surface of the deck.

3. The apparatus of claim 1, wherein the first end of the moveable member is configured to receive force applied from a foot of a rider of the skateboard.

4. The apparatus of claim 1, wherein the actuation assembly further includes an adjustment portion configured to selectively adjust a distance of the one or more friction elements from the ground surface when a force is not applied to the first end of the moveable member.

5. The apparatus of claim 1, wherein the moveable member extends in a substantially vertical direction through an opening defined in the skateboard deck from the top surface to the bottom surface.

6. The apparatus of claim 1, wherein the one or more friction elements are removable and interchangeable.
